(19) United States
(12) Patent Application Publication
(10) Pub. No.: US 2007/0285055 A1
(43) Pub. Date: Dec. 13, 2007

(54) BATTERY PACK

(76) Inventors: Gary D. Meyer, Waukesha, WI (US); Jay J. Rosenbecker, Menomonee Falls, WI (US); Kevin L. Glasgow, Lomira, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 11/759,708

(22) Filed: Jun. 7, 2007

Related U.S. Application Data
(60) Provisional application No. 60/811,678, filed on Jun. 7, 2006.

(51) Int. Cl. H02J 7/00

(52) U.S. Cl. 320/116

(57) ABSTRACT

A rechargeable battery pack. The battery pack includes a plurality of battery cells, a positive terminal, a charging switch, and a negative terminal. The plurality of battery cells are connected in series and include a first battery cell and a last battery cell. The charging switch is electrically coupled between the positive terminal and a positive node of the first battery cell and is configured to open when the battery cells are substantially charged. The negative terminal is electrically coupled to a negative node of the last battery cell.

### RELATED APPLICATION

This patent application claims the benefit of prior filed U.S. Provisional Patent Application No. 60/811,678, filed Jun. 7, 2006, the entire contents of which are hereby incorporated by reference.

### FIELD

Embodiments of the invention relate to battery packs, and, more particularly, to rechargeable battery packs.

### BACKGROUND

Various embodiments of prior art battery packs are shown in FIGS. 1 and 2. A four (4) terminal prior art battery pack 20 is shown in FIG. 1. A three (3) terminal prior art battery pack 25 is shown in FIG. 2. The prior art battery packs 20 and 25 are used to power one or more prior art electrical devices, such as one or more prior art power tools. For example, as shown in FIG. 4, the prior art battery pack 20 is used to power a prior art electrical device, such as a prior art power tool 28. The prior art battery packs 20 and 25 can also receive power from one or more prior art electrical devices, such as one or more prior art battery chargers. For example, as shown in FIGS. 3 and 5, the prior art battery packs 20 and 25 are used to receive power from prior art electrical devices, such as prior art battery chargers 65 and 120.

The prior art battery packs 20 and 25 each include a plurality of battery cells 30 and 35, respectively. The battery cells 30 and 35 typically have a chemistry of Nickel Cadmium (“NiCd”) or Nickel Metal Hydride (“NiMH”). Typically, prior art battery chargers, such as battery chargers 65 and 120, are programmed to identify specific prior art battery packs and charge only those prior art packs which can be properly identified. Any battery pack that the prior art battery charger cannot identify will not be charged by the prior art battery charger.

As shown in FIG. 1, the four terminal prior art battery pack 20 includes four terminals: a first positive battery terminal 40, a second positive battery terminal 45, a sense battery terminal 50 and a negative battery terminal 55. The first positive battery terminal 40 and the negative battery terminal 55 physically and electrically connect to an electrical device, such as the prior art power tool 28, to provide a discharge current to the electrical device. The second positive battery terminal 45, the sense battery terminal 50 and the negative battery terminal 55 physically and electrically connect to an electrical device, such as a prior art battery charger 65, to receive a charging current from the electrical device.

As shown in FIG. 1, an identification device 60 is electrically connected to the sense battery terminal 50 and the negative battery terminal 55. In some constructions, the identification device 60 provides a specific reading, such as a resistance value, that can be identified by prior art battery chargers, such as the prior art battery charger 65 shown in FIG. 3. A reading that falls within an acceptable range means that the battery charger 65 can identify the battery pack 20 via the identification device 60 and thus charge the pack accordingly. The identification device 60 can include a resistor, a thermistor, a thermostat, a logic device or another electrical resistive component. In the construction shown, the identification device 60 is a temperature-sensing device, such as a thermistor.

As shown in FIG. 2, the three terminal prior art battery pack 25 includes three terminals: a positive battery terminal 70, a sense battery terminal 75 and a negative battery terminal 80. The positive battery terminal 70 and the negative battery terminal 80 physically and electrically connect to an electrical device, such as a prior art power tool (not shown), to provide a discharge current to the electrical device. The positive battery terminal 70, the sense battery terminal 75 and the negative battery terminal 80 physically and electrically connect to an electrical device, such as a prior art battery charger 120 of FIG. 5, to receive a charging current from the electrical device.

An identification device 85, similar to the identification device 60, is electrically connected to the sense battery terminal 75 and the negative battery terminal 80. In the construction shown, the identification device 80 is a temperature-sensing device, such as a thermostat.

FIG. 3 shows the four terminal prior art battery pack 20 electrically connected to a first prior art battery charger 65. In this construction, the prior art battery charger 65 is operable to identify the prior art battery pack 20, to identify the chemistry of the battery cells 30 and to properly charge the pack 20 accordingly. The prior art battery charger 65 includes a controller 90 operable to control the charging current supplied to the prior art battery pack 20 by the charging circuit 95. The controller 90 is also operable to identify the prior art battery pack 20 via the identification device 60 and charge the pack 20 accordingly.

The prior art battery charger 65 also includes a positive charging terminal 100, a sense charging terminal 105 and a negative charging terminal 110. The positive charging terminal 100 is configured to physically and electrically connect to the second positive battery terminal 45 of the prior art battery pack 20. The sense charging terminal 105 is configured to physically and electrically connect to the sense battery terminal 50, and the negative charging terminal 110 is configured to physically and electrically connect to the negative battery terminal 55 of the prior art battery pack 20.

During operation in this construction, the controller 90 monitors the voltage across the sense charging terminal 105 and the negative charging terminal 110 during charging. From that reading, the controller 90 can determine the temperature of the battery cells 30. If the temperature determination is acceptable, the battery charger 65 continues to supply the charging current to the battery pack 20. If the temperature determination is not acceptable, the controller 90 determines that the battery pack 20 has completed charging, and the battery charger 65 supplies a trickle charge to the battery pack 20 until the battery pack 20 is physically and electrically disconnected from the charger 65.

FIG. 5 shows the three terminal prior art battery pack 25 electrically connected to a second prior art battery charger 120. In this construction, the prior art battery charger 120 is operable to identify the prior art battery pack 25, to identify the chemistry of the battery cells 35 and to properly charge the pack 25 accordingly. The second prior art battery charger 120 includes similar components as the first prior art battery charger 65. The controller 90 is operable to identify the prior art battery pack 25 via the identification device 85 and charge the pack 20 accordingly.

During operation in this construction, the prior art battery charger 120 provides a charging current to the prior art battery pack 25 when the thermostat 85 is conducting current. When the temperature of the battery cells 35 exceeds the threshold temperature of the thermostat 85, the thermostat 85 no longer conducts current, indicating to the prior art battery charger 120 that the pack 25 has neared charge completion. The controller 90 senses the interruption of current through the sense charging terminal 105, and the prior art battery charger 120 supplies a trickle charge to the battery pack 25 until the battery pack 25 is physically and electrically disconnected from the charger 120.

### SUMMARY

In some aspects, the invention provides a battery pack having a chemistry differing from existing battery packs and capable of being charged by an existing battery charger.

In one embodiment, the invention provides a rechargeable battery pack. The battery pack includes a plurality of battery cells, a positive terminal, a charging switch, and a negative terminal. The plurality of battery cells are connected in series and include a first battery cell and a last battery cell. The charging switch is electrically coupled between the positive terminal and a positive node of the first battery cell and is configured to open when the battery cells are substantially charged. The negative terminal is electrically coupled to a negative node of the last battery cell.

In another embodiment, the invention provides an electrical combination including a battery charger and a rechargeable battery pack. The rechargeable battery pack includes a plurality of battery cells having a chemistry not compatible with the charger. The battery pack also includes circuitry to provide one or more signals to the battery charger equivalent to signals output by a second battery pack that is compatible with the charger. The circuitry also protects the battery cells from damage caused by the incompatibility of the battery pack and the battery charger.

In another embodiment, the invention provides a method of charging a battery. The battery is coupled to a charger and has a chemistry not supported by the charger. The method includes providing a signal to the charger, modifying a constant charging current provided by the charger, and blocking a trickle current provided by the charger. The signal identifies at least one characteristic of the battery to the charger indicating that the battery is supported by the charger. The constant charging current provided by the charger is modified into a pulsed charging current.

Other aspects of the invention will become apparent by consideration of the detailed description and accompanying drawings.

### BRIEF DESCRIPTION OF THE DRAWINGS

FIG. 1 is a schematic drawing of a prior art battery pack.

FIG. 2 is a schematic drawing of another prior art battery pack.

FIG. 3 is a schematic drawing of a prior art electrical combination of a prior art battery charger and a prior art battery pack, such as the battery pack illustrated in FIG. 1.

FIG. 4 is a schematic drawing of another prior art electrical combination of a prior art electrical device and a prior art battery pack, such as the battery pack illustrated in FIG. 1.

FIG. 5 is a schematic drawing of another prior art electrical combination of a prior art battery charger and a prior art battery pack, such as the battery pack illustrated in FIG. 2.

FIG. 6 is a schematic drawing of a battery pack according to an embodiment of the invention.

FIG. 7 is a schematic drawing of another battery pack according to an embodiment of the invention.

FIG. 8 is a schematic drawing of a further battery pack according to an embodiment of the invention.

FIG. 9 is a schematic drawing of still a further battery pack according to an embodiment of the invention.

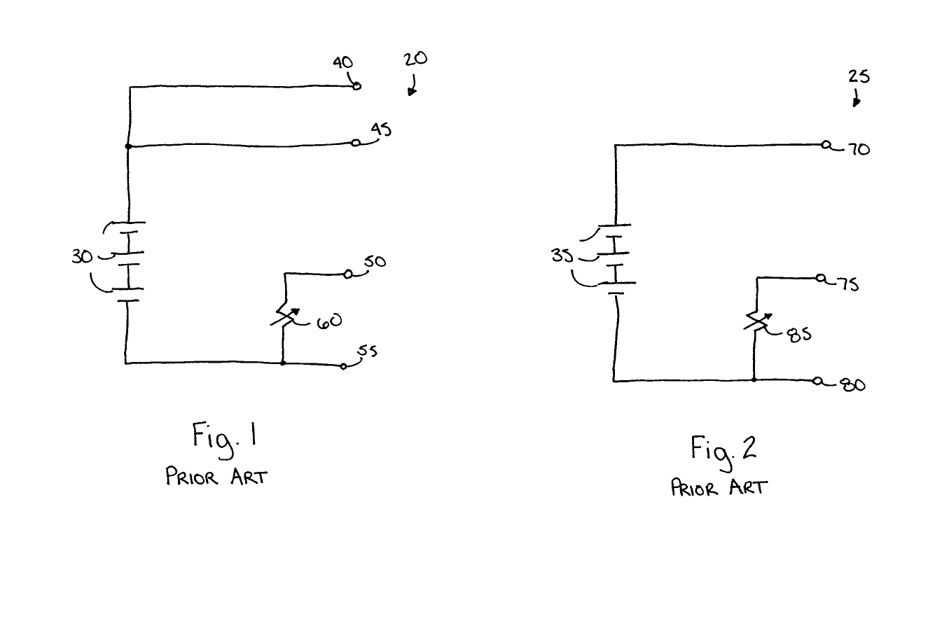

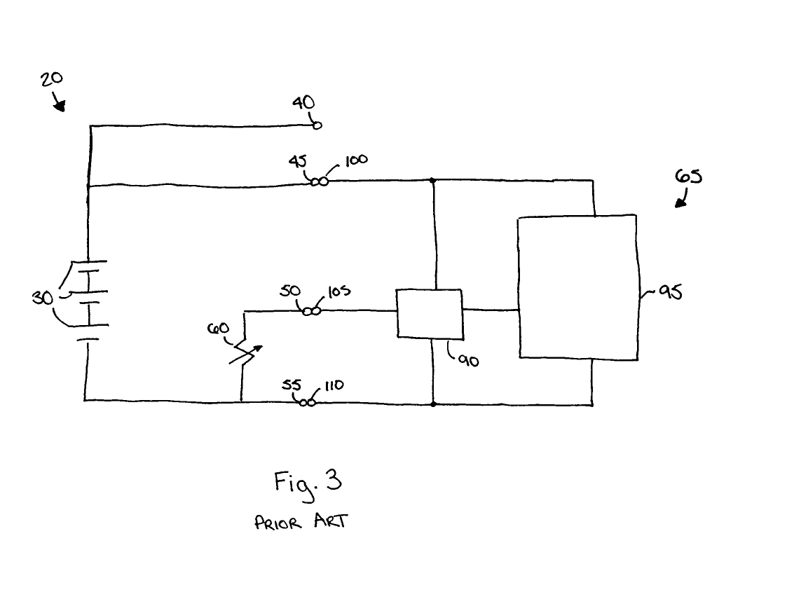

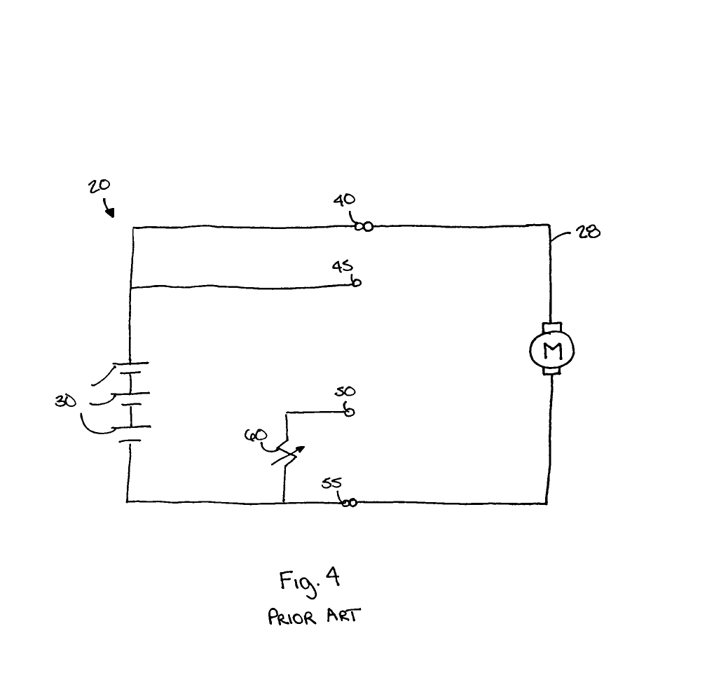

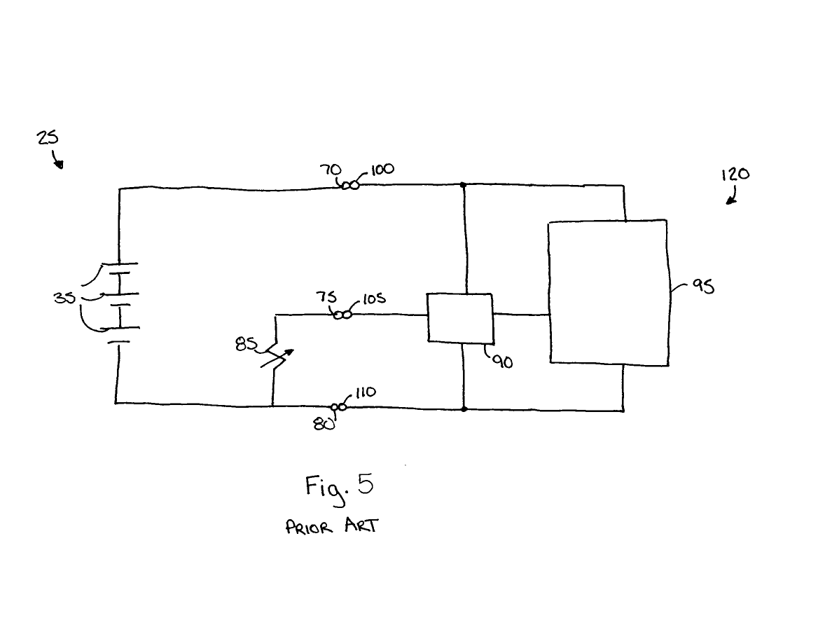

Before embodiments of the invention are explained in detail, it is to be understood that the invention is not limited in its application to the details of the construction and the arrangements of the components set forth in the following description or illustrated in the drawings. The invention is capable of other embodiments and of being practiced or carried out in various ways. In addition, it is understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Unless limited otherwise, the terms “connected,” “coupled” and variations thereof herein are used broadly to encompass direct and indirect connections and couplings. In addition, the terms “connected” and “coupled” and variations thereof are not restricted to physical or mechanical connections or couplings.

### DETAILED DESCRIPTION

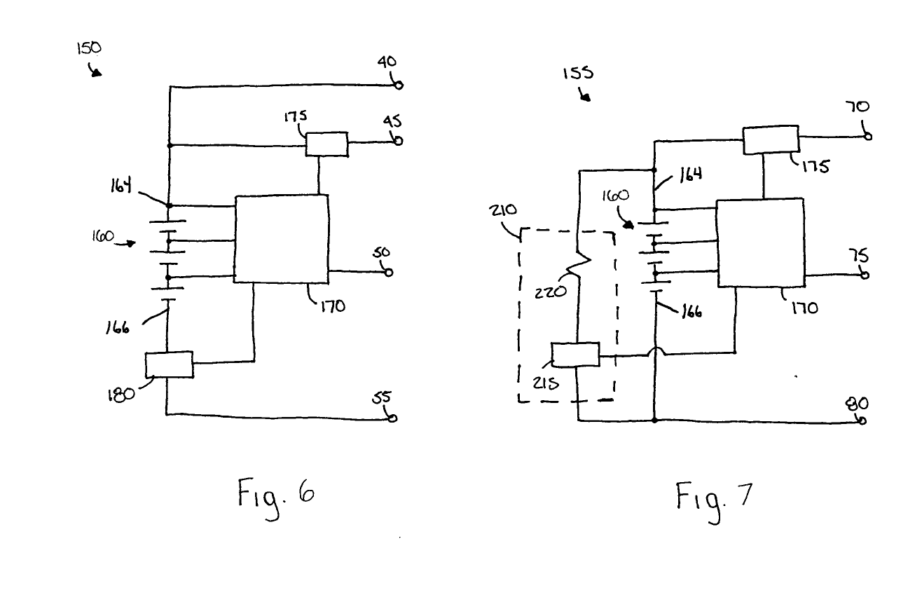

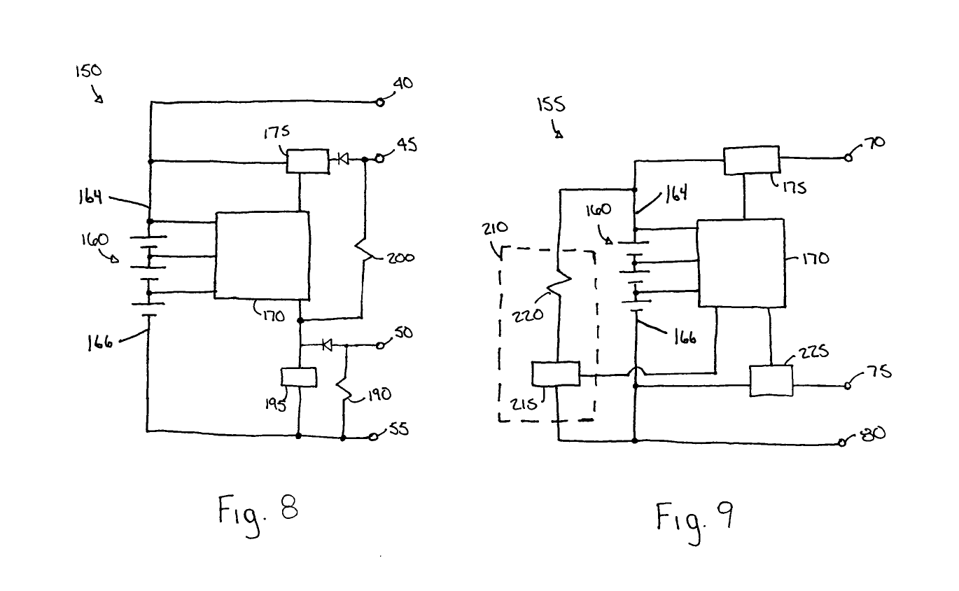

Various constructions of rechargeable battery packs are shown in FIGS. 6-9. A four (4) terminal battery pack 150 is shown in FIGS. 6 and 8, and a three (3) terminal battery pack 155 is shown in FIGS. 7 and 9. Battery packs 150 and 155 are used to power one or more electrical devices, such as one or more power tools, cars, planes, boats, etc. (not shown). In one construction, the electrical devices can be powered by various battery packs each having a different chemistry. In other words, the electrical devices can receive power from batteries of different battery chemistries.

Battery packs 150 and 155 both include a plurality of battery cells 160, each cell 160 having a positive node and a negative node. In one construction, the battery cells 160 have a lithium-based chemistry, such as a Li-ion chemistry. In other constructions, the battery cells 160 have a chemistry that has not been previously used by prior art battery packs, such as packs 20 and 25, and thus the prior art battery chargers, such as prior art battery chargers 65 and 120, are not programmed to identify and/or properly charge that chemistry. In the constructions shown, the battery cells 160 are connected in series such that the resulting group of battery cells 160 has a positive node 164 (i.e., a positive node of a first battery cell 160) and a negative node 166 (i.e., a negative node of a last battery cell 160).

As shown in FIGS. 6 and 8, the battery pack 150 includes the same battery terminals as the prior art battery pack 20, such that the battery pack 150 can mate with existing prior art battery chargers, such as battery charger 65, and existing prior art power tools, such as power tool 28.

The battery pack 150 includes a controller 170. The controller 170 monitors various conditions of the battery pack 150 during discharge and charge, controls the operation of the pack 150 and controls various components included in the pack 150. In other constructions, the controller 170 can be a control circuit of one or more logic, digital and/or analog components.

The battery pack 150 also includes a charging switch 175 positioned within the electrical path between the plurality of battery cells 160 and the second positive battery terminal 45. The controller 170 controls the operation of the switch 175 and thus controls the amount of charging current being supplied to the battery cells 160 through the switch 175. In one construction, the controller 170 controls the switch 175 such that the charging current is supplied to the battery cells 160 in a pulse mode manner, such as the manner described in co-pending U.S. patent application Ser. No. 10/719,680, filed Nov. 20, 2003, now U.S. Pat. No. 7,176,654, issued Feb. 13, 2007, and U.S. patent application Ser. No. 11/139,020, filed May 24, 2005, the entire contents of both of which are hereby incorporated by reference. The charging switch 175 can be any suitable switch, such as a field effect transistor (“FET”) or a MOSFET.

In the illustrated construction of FIG. 6, the battery pack 150 also includes a discharging switch 180 positioned within the electrical path between the battery cells 160 and the negative battery terminal 55. The controller 170 can also control the discharging switch 180, such that the switch 180 can interrupt the discharging current when the controller 170 senses an abnormal battery condition, as described in co-pending U.S. patent application Ser. No. 10/720,027, filed on Nov. 20, 2003, now U.S. Pat. No. 7,157,882, issued Jan. 2, 2007, and U.S. patent application Ser. No. 11/138,070, filed on May 24, 2005, the entire contents of both of which are hereby incorporated by reference. In other constructions, the battery pack 150 can include similar components as the battery packs described in the incorporated references.

In order for the battery pack 150 to be charged by existing prior art battery chargers, such as prior art battery charger 65, the existing battery charger has to be able to recognize and identify the battery pack 150. In the construction shown in FIG. 6, the controller 170 provides the necessary outputs or readings on the sense battery terminal 50 such that the existing battery charger 65 interprets the readings as coming from an existing battery pack, such as battery pack 20. In this construction, the controller 170 outputs a reading similar to that provided by the identification device 60 of the prior art battery pack 20. The existing battery charger 65 supplies a charging current to the battery pack 150, which is controlled by the controller 170 via the charging switch 175. When the controller 170 senses that the battery cells 160 have completed charging, the controller 170 supplies a reading to the charger 65 indicating that the battery temperature is within a non-accepted range (i.e., the battery temperature is too high). The prior art charger 65 interprets the reading as being the end of charge for the battery 150 and thus supplies a trickle charge to the battery 150. The controller 170 opens the switch 175, such that no trickle charge can be supplied to the battery cells 160.

In the construction shown in FIG. 8, the battery 150 operates in a similar manner to the construction shown in FIG. 6. However, instead of the controller 170 supplying the reading to the sense battery terminal 50, an identification device 190 is positioned between the battery sense terminal 50 and the negative battery terminal 55. In one construction, the identification device 190 can be similar to the identification device 60 of the prior art battery pack 20. In this construction, the identification device 190 is a temperature-sensing device, such as a thermistor.

In operation, the controller 170 operates the charging switch 175 in a similar manner to that described above with respect to FIG. 6, but the identification device 190 provides the readings for the prior art battery charger 65. When the battery cells 160 complete charging, the controller 170 opens the charging switch 175 to interrupt the charging current and simultaneously closes a second switch 195. Closing the second switch 195 is perceived by the existing battery charger 65 as the reading from the identification device 190 falling outside an acceptable range. Thus, the prior art battery charger 65 perceives that the battery pack 150 has completed charging and supplies a trickle charge to the battery pack 150. In this construction, assuming that the battery cells 160 within the battery pack have a lithium-based chemistry and are thus sensitive to overcharging, the trickle charge is dissipated or redirected through a resistive element 200 and the closed second switch 195. The resistive element 200 has a resistive value such that the voltage across the second positive battery terminal 45 and the negative battery terminal 55 is within an acceptable range for the prior art battery charger 65. In one construction, an acceptable voltage can be approximately 10V. In other constructions, the acceptable voltage can be less than or greater than 10V.

In some constructions, it may be important to provide an acceptable voltage across the terminals 45 and 55 such that the prior art battery charger 65 displays a charge completed signal to the user and does not display a defective battery pack signal to the user.

As shown in FIGS. 7 and 9, the battery pack 155 includes the same battery terminals as the prior art battery pack 25, such that the battery pack 155 can mate with existing prior art battery chargers, such as battery charger 120, and existing prior art power tools.

The battery pack 155 also includes similar components as battery pack 150, such as the controller 170 and charging switch 175, and operates in a similar manner.

When the controller 170 of the pack 155 detects that the cells 160 have completed charging, the controller 170 opens the switch 175. However, in some instances, the open switch 175 may still allow a very small amount of charge to pass through and be supplied to the battery cells 160. In these instances, the battery pack 155 includes a bleeder circuit 210 for dissipating this small amount of charge passing through the switch 175. In operation, when the controller 170 opens the switch 175, the controller 170 simultaneously closes a switch 215 in the bleeder circuit 210. Instead of charging the battery cells 160, the current passes through the bleeder circuit 210 and is dissipated as heat through a resistive element 220.

As shown in FIG. 9, the battery pack 155 also includes a third switch 225. The third switch 225, under the control of the controller 170, can simulate the thermostat 85 of the prior art battery pack 25. When the controller 170 detects that the cells 160 have completed charging, the controller 170 can open the third switch 225. To the prior art battery charger 120, it appears as though the thermostat 85 is open and thus, that the battery pack 155 has completed charging. The switch 225 will remain open such that the battery charger 120 displays a charge complete signal to the user.

Although the invention has been described in detail with reference to certain preferred embodiments (i.e., battery packs for power tools), variations and modifications exist within the scope and spirit of one or more independent aspects of the invention as described including, but not limited to, cars, planes, boats, toys, yard equipment, cameras, computers, and audio equipment.

What is claimed is:

1. A rechargeable battery pack, comprising:
a plurality of battery cells connected in series, the plurality of battery cells including a first battery cell and a last battery cell;
a positive terminal;
a charging switch electrically coupled between the positive terminal and a positive node of the first battery cell, the charging switch configured to open when the battery cells are substantially charged; and
a negative terminal electrically coupled to a negative node of the last battery cell.

2. The battery pack of claim 1, wherein the battery pack is rechargeable by a battery charger and wherein the battery cells have a chemistry not supported by the battery charger.

3. The battery pack of claim 1, further comprising a controller configured to control the charging switch.

4. The battery pack of claim 3, wherein the controller controls the charging switch such that the charging switch receives a constant charging current from a battery charger and provides a pulsed charging current to the battery cells.

5. The battery pack of claim 3, further comprising a sense terminal, wherein the controller provides a signal to the sense terminal.

6. The battery pack of claim 5, wherein the signal is equivalent to a signal provided by a second battery pack having a different chemistry.

7. The battery pack of claim 5, wherein the signal indicates when the battery pack is substantially charged.

8. The battery pack of claim 5, wherein the signal indicates when a temperature of the battery pack is within a temperature range.

9. The battery pack of claim 1, further comprising a sense terminal and an identification device, the identification device coupled between the sense terminal and the negative terminal.

10. The battery pack of claim 9, further comprising a sense switch connected in parallel with the identification device.

11. The battery pack of claim 10, wherein the sense switch is configured to open when the battery cells are fully charged.

12. The battery pack of claim 1, wherein the charge switch is a field effect transistor.

13. The battery pack of claim 1, further comprising a discharge switch coupled between the negative node of the last battery cell and the negative terminal.

14. The battery pack of claim 13, further comprising a controller, wherein the discharge switch is controlled by the controller.

15. The battery pack of claim 14, wherein the controller opens the discharge switch when a voltage of a battery cell is below a threshold voltage.

16. The battery pack of claim 1, further comprising a circuit configured to dissipate current when the charging switch is open.

17. The battery pack of claim 16, wherein the circuit provides a voltage indicating to a battery charger that the battery pack is substantially charged.

18. The battery pack of claim 16, wherein the circuit includes a resistor and a bleeder switch, the resistor coupled between the positive end of the battery cells and the bleeder switch, the bleeder switch coupled between the resistor and the negative terminal.

19. The battery pack of claim 16, wherein the bleeder switch is closed when the charging switch is open and the bleeder switch is open when the charging switch is closed.

20. The battery pack of claim 1, further comprising a discharge positive terminal coupled to the positive end of the battery cells.

21. The battery pack of claim 1, further comprising a sense switch coupled between the negative terminal and the negative end of the battery cells.

22. An electrical combination, comprising:
a battery charger; and
a rechargeable battery pack including a plurality of battery cells having a chemistry not compatible with the charger, the battery pack including circuitry to provide one or more signals to the battery charger equivalent to signals output by a second battery pack compatible with the charger and to protect the battery cells from damage caused by the incompatibility of the battery pack and the battery charger.

23. The electrical combination of claim 22, wherein the circuitry prevents a trickle charge, from the battery charger, from reaching the battery cells.

24. The electrical combination of claim 22, wherein the charger provides a constant charging current.

25. The electrical combination of claim 24, wherein the circuitry modifies the constant charging current into a pulsed charging current.

26. A method of charging a battery coupled to a charger, the battery having a chemistry not supported by the charger, the method comprising:
providing a signal to the charger identifying at least one characteristic of the battery to the charger, the signal indicating that the battery is supported by the charger;
modifying a constant charging current provided by the charger; and
blocking a trickle current provided by the charger.

27. The method of claim 26, wherein the modifying act comprises converting the constant charging current into a pulsed charging current.

28. The method of claim 26, further comprising providing a signal to the charger indicating that the battery is fully charged.
